(19) United States
(12) Patent Application Publication
(10) Pub. No.: US 2022/0008969 A1
(43) Pub. Date: Jan. 13, 2022

(54) FUME HOOD AIR CHANNELING DEVICE

(71) Applicant: Timothy McKibben, Colorado, CO (US)

(72) Inventor: Timothy McKibben, Colorado, CO (US)

(21) Appl. No.: 17/367,007

(22) Filed: Jul. 2, 2021

Related U.S. Application Data
(63) Continuation of application No. 15/962,966, filed on Apr. 25, 2018, now abandoned.

(51) Int. Cl. B08B 15/02

(52) U.S. Cl. CPC B08B 15/023

(57) ABSTRACT

In one embodiment, a laboratory fume hood equipment air channeling system may include a platform having a plurality of vertical air channels therethrough, support legs configured to hold the platform above the countertop work surface of a laboratory fume hood, and an air chamber formed beneath the platform. The platform may include a lattice of interconnected horizontal slats forming a plurality of vertical air channels through the platform. The platform may have sidewall surfaces, an upper surface, and a lower surface. The support legs may be attached to the platform to hold the platform above the countertop work surface of the laboratory fume hood. The countertop work surface and the lower surface of the platform may form the air chamber beneath the platform. The air chamber may be in fluid communication with the vertical air channels increasing air flow through the vertical air channels and increasing air flow horizontally from front to back of the laboratory fume hood along the countertop work surface. The air chamber being in fluid communication with the vertical air channels increases the air flow around all sides of one or more laboratory equipment located on the upper surface of the platform. The sidewall surfaces, the upper surface, and the lower surface of the platform with the vertical air channels may together define a bulk volume of the platform, the bulk volume having void space defined by the vertical air channels. In one example, the bulk volume comprises at least 70% void space.

### CROSS REFERENCE TO RELATED APPLICATIONS

This application claims priority to copending U.S. application Ser. No. 15/962,966, filed on Apr. 25, 2018, which is hereby incorporated by reference for all purposes.

### BACKGROUND

The present disclosure relates generally to accessories for laboratory fume hoods. In particular devices for channeling air and supporting laboratory equipment within the laboratory fume hood are described.

Existing methods of using laboratory fume hoods are not entirely satisfactory for the range of applications in which they are employed. For example, existing laboratory fume hoods may become clogged with laboratory equipment, obstructing air flow where it is needed most and causing dangerous conditions within the laboratory fume hood.

Thus, there exists a need for systems that improve upon and advance the design of accessories for existing laboratory fume hoods. Examples of new and useful systems relevant to the needs existing in the field are discussed below.

### SUMMARY

In one embodiment, a laboratory fume hood equipment air channeling system may include a platform having a plurality of vertical air channels therethrough, support legs configured to hold the platform above the countertop work surface of a laboratory fume hood, and an air chamber formed beneath the platform. The platform may include a lattice of interconnected horizontal slats forming a plurality of vertical air channels through the platform. The platform may have sidewall surfaces, an upper surface, and a lower surface. The support legs may be attached to the platform to hold the platform above the countertop work surface of the laboratory fume hood. The countertop work surface and the lower surface of the platform may form the air chamber beneath the platform. The air chamber may be in fluid communication with the vertical air channels increasing air flow through the vertical air channels and increasing air flow horizontally from front to back of the laboratory fume hood along the countertop work surface. The air chamber being in fluid communication with the vertical air channels increases the air flow around all sides of one or more laboratory equipment located on the upper surface of the platform. The sidewall surfaces, the upper surface, and the lower surface of the platform with the vertical air channels may together define a bulk volume of the platform, the bulk volume having void space defined by the vertical air channels. In one example, the bulk volume comprises at least 70% void space.

### BRIEF DESCRIPTION OF THE DRAWINGS

FIG. 1 is a perspective view of a first example of a laboratory fume hood air channeling system.

FIG. 2 is a perspective view of the laboratory fume hood air channeling system of FIG. 1 depicting laboratory equipment in place and in use in the laboratory fume hood.

FIG. 3 is a perspective view of the laboratory fume hood air channeling system of FIG. 1 depicting laboratory equipment in place and in use in the laboratory fume hood.

FIG. 4 is a detail view of a portion of the laboratory fume hood air channeling system of FIG. 1 depicting the vertical air channels.

FIG. 5 is a plan view of the laboratory fume hood air channeling system of FIG. 1 in place in a laboratory fume hood.

### DETAILED DESCRIPTION

The disclosed laboratory fume hood air channeling devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various laboratory fume hood air channeling devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

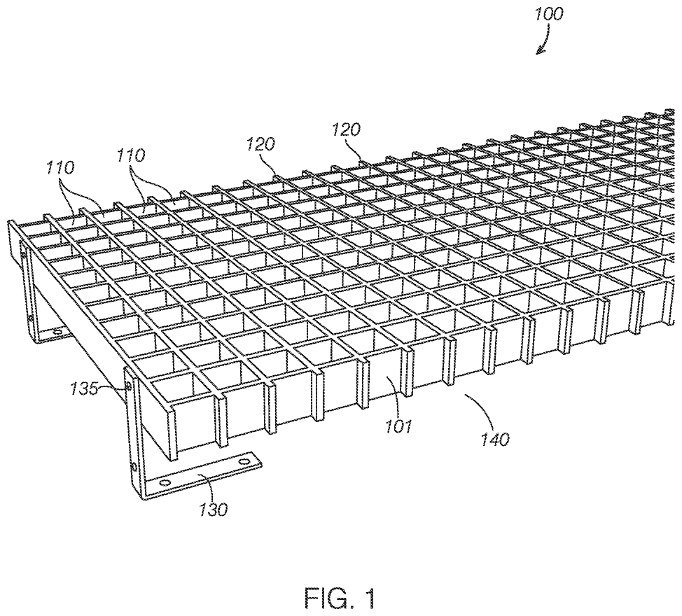

With reference to FIGS. 1-5, a first example of a laboratory fume hood air channeling device, device 100 will now be described. Device 100 functions to distribute and channel air flow past laboratory equipment in a laboratory fume hood. The reader will appreciate from the figures and description below that device 100 addresses shortcomings of conventional laboratory fume hoods.

Device 100 includes a platform 101 including vertical air channels 110, support legs 130, and an air chamber 140.

As can be seen in FIG. 1, platform 101 may be comprised of a lattice of interconnected horizontal slats 120 which form a plurality of vertical air channels 110. In the illustrated embodiment, the vertical air channels 110 have a rectangular cross section. In other embodiments, the vertical air channels may have any other suitable shape such as cylinders.

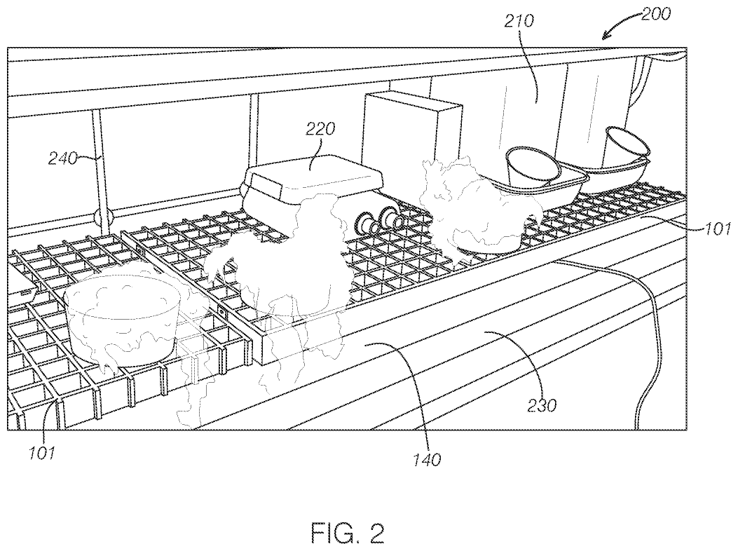

The platform 101 may be sized to fit within the laboratory fume hood (as shown in FIGS. 2, 3, 5). In one embodiment, platform 101 may be sized to essentially match the dimensions of a countertop work surface inside of the laboratory fume hood. In other embodiments, the platform 101 may be sized to cover only a portion of the countertop work surface, for example approximately half the countertop work surface. The platform 101 may have an upper surface and a lower surface.

Support legs 130 function to hold the platform 101 above the countertop work surface of the laboratory fume hood. For example, the support legs 130 may position the platform 101 such that the lower surface of the platform 101 is several inches above, and essentially parallel with, the countertop work surface in the laboratory fume hood. Thus, a long horizontal air chamber 140 may be formed beneath platform 101

Support legs 130 may be attached to the exterior of the platform 101 via fasteners 135. In the illustrated embodiment, the support legs 130 comprise L-shaped metal bodies. In other embodiments, the support legs 130 may comprise cylindrical or tubular members. The support legs 130 may be made of plastic, glass, carbon, metal and/or composite. In some embodiments, the support legs 130 may be adjustable in height. For example, the support legs 130 may include a series of holes sized to accept the fastener 135, thus the height of the support legs 130 may be adjusted by selecting another one of the series of holes to place the fastener 135 through. In other embodiments, the support legs 130 may be telescoping or otherwise adjustable.

Turning now to FIG. 2, the air chamber 140 functions to distribute air to each of the vertical air channels 110. Laboratory equipment 210, 220 may be placed on the upper surface of platform 101, as shown. Thus, by placing device 100 beneath the laboratory equipment 210, 220, the air flow on all sides of the laboratory equipment 210, 220 may be drastically increased as compared with placing the laboratory equipment 210, 220 directly on the countertop work surface 230 of the laboratory fume hood 200.

The platform may be constructed of plastic, glass, carbon, metal and/or composite. In one embodiment, the platform 101 is comprised of one or more materials having a Class A fire rating, as defined by the National Fire Protection Association (NFPA).

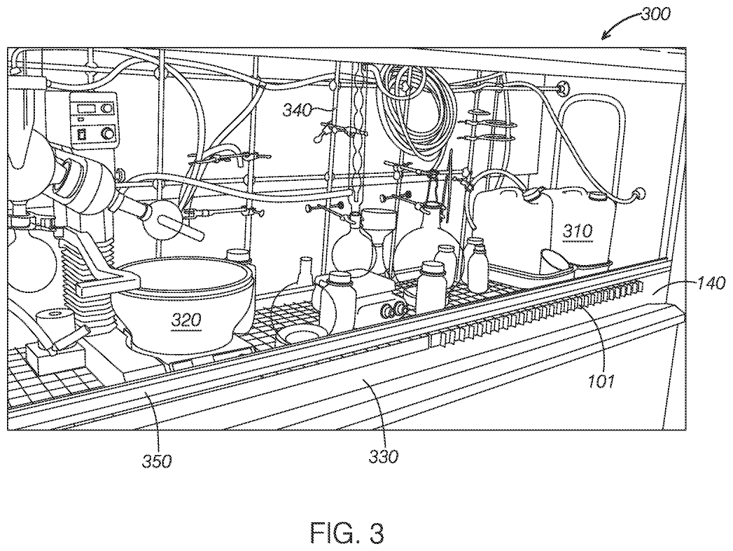

Turning now to FIG. 3, in one embodiment, laboratory fume hood sash 350 may be lowered such that the air chamber 140 is open to the ambient environment to collect air, while the laboratory equipment 310, 320 in the laboratory fume hood 300 is behind the clear glass of the laboratory fume hood sash 350. Thus, the air flow around the laboratory equipment may be maintained even while the laboratory equipment is behind the protective glass of the laboratory fume hood sash 350.

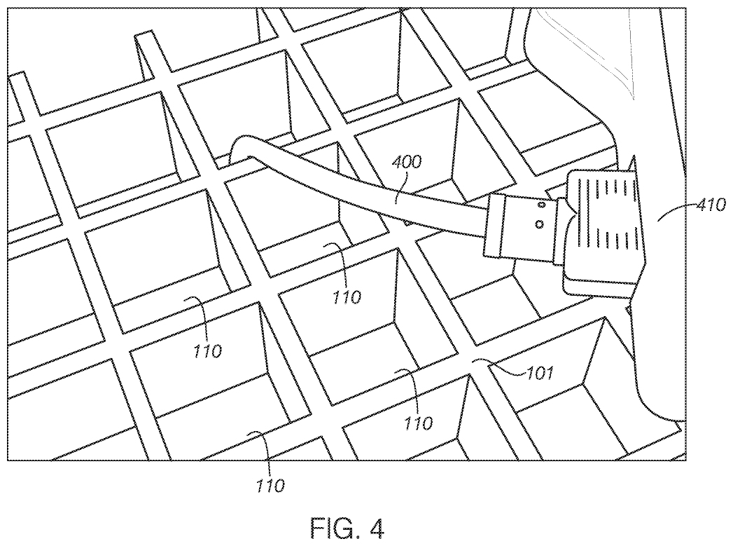

Turning now to FIG. 4, a detailed view of platform 101 is shown. As can be seen, the vertical air channels 110 may be sized such that an electrical plug 400 of a piece of laboratory equipment 410 may be passed through the one of the vertical air channels 110. Thus, laboratory equipment requiring electrical plugs may be placed anywhere on the platform 101.

Furthermore, as can be seen in FIG. 4, the vertical air channels 110 define void space in the platform 101. The platform 101 may have sidewall surfaces, wherein the sidewall surfaces together with the upper and lower surfaces and vertical air channels 110 define a bulk volume of the platform 101. The bulk volume of the platform 101 may comprise between 50% and 70% void space. For example, in one embodiment, the bulk volume of the platform 101 comprises at least 50% void space. In one embodiment, the bulk volume of the platform 101 comprises at least 60% void space. In one embodiment, the bulk volume of the platform 101 comprises at least 65% void space. In one embodiment, the bulk volume of the platform 101 comprises at least 70% void space.

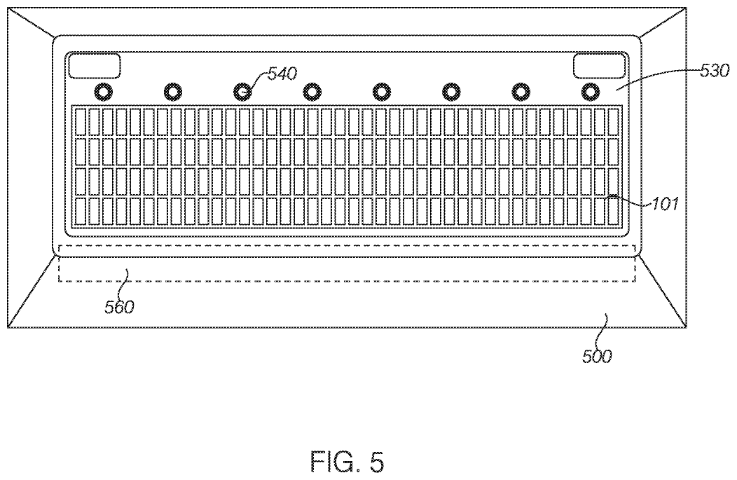

Turning now to FIG. 5, a plan view of platform 101 inside laboratory fume hood 500 is shown. As can be seen, the platform 101 may extend side to side and front to back so as to be essentially coextensive with the countertop work surface 530 inside the laboratory fume hood 500. The platform 101 may extend from the back of the laboratory fume hood 500, or from one or more support racks 540 located at the back of the laboratory fume hood 500, to airfoil 560 located at the front of the laboratory fume hood 500.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A laboratory fume hood air channeling system comprising:
a platform comprising:
a lattice of interconnected horizontal slats forming a plurality of vertical air channels through the platform;
an upper surface;
a lower surface; and
support legs coupled to the platform, configured to hold the platform above a countertop work surface of the laboratory table fume hood,
wherein the platform fits within the laboratory table fume hood and extends side to side and front to back so as to be substantially coextensive with the countertop work surface of the laboratory table fume hood,
wherein the countertop work surface and the lower surface of the platform cooperatively define an air chamber beneath the platform and above the countertop work surface of the laboratory table fume hood,
wherein the air chamber is in fluid communication with the vertical air channels increasing the air flow through the vertical air channels and increasing air flow horizontally from front to back of the laboratory fume hood along the countertop work surface,
wherein the lattice of interconnected horizontal slats of the platform support one or more laboratory equipment on the upper surface of the platform, and
wherein the air chamber being in fluid communication with the vertical air channels increases the air flow around all sides of the one or more laboratory equipment located on the upper surface of the platform.

2. The system of claim 1, wherein the platform includes sidewall surfaces; and
wherein the sidewall surfaces, the upper surface, the lower surface, and vertical air channels together define a bulk volume of the platform, the bulk volume having void space defined by the vertical air channels.

3. The system of claim 2, wherein the bulk volume comprises between 50% and 70% void space.

4. The system of claim 1, wherein the lattice of interconnected horizontal slats of the platform substantially supports the one or more laboratory equipment on the upper surface of the platform, and wherein the one or more laboratory equipment comprises enough laboratory equipment to clog the laboratory fume hood.

5. The system of claim 1, wherein the lower surface of the platform is no more than 7.583 inches above the countertop work surface of the laboratory fume hood.

6. The system of claim 1, wherein the support legs comprise a thin profile minimizing disruption of the air channel.

7. The system of claim 1, wherein the vertical air channels have one or more of a rectangular or cylindrical opening.

8. The system of claim 1, wherein the vertical air channels are sized to pass an electrical plug therethrough.

9. The system of claim 1, wherein the platform is comprised of a material having a Class A Fire Rating, as defined by the National Fire Protection Association.

10. The system of claim 1, wherein the support legs are coupled exteriorly to the platform.

11. A laboratory fume hood air channeling system comprising:
a platform comprising a lattice of interconnected horizontal slats forming a plurality of vertical air channels through the platform, the platform having sidewall surfaces, an upper surface and a lower surface; and
support legs coupled exteriorly to the platform, configured to hold the platform above a countertop work surface of the laboratory fume hood, the countertop work surface and the lower surface of the platform forming an air chamber beneath the platform, the air chamber being in fluid communication with the vertical air channels,
wherein the sidewall surfaces, the upper surface, the lower surface, and vertical air channels together define a bulk volume of the platform, the bulk volume having void space defined by the vertical air channels.

12. The system of claim 11, wherein the bulk volume comprises between 50% and 70% void space.

13. The system of claim 11, wherein the support legs comprise a thin profile minimizing disruption of the air channel.

14. The system of claim 11, wherein the vertical air channels have one or more of a rectangular or cylindrical opening.

15. The system of claim 11, wherein the vertical air channels are sized to pass an electrical plug therethrough.

16. The system of claim 11, wherein the platform fits within the laboratory table fume hood and extends side to side and front to back so as to be substantially coextensive with the countertop work surface of the laboratory table fume hood.

17. The system of claim 11, wherein the air chamber being in fluid communication with the vertical air channels increases the air flow through the vertical channels and increases air flow horizontally from front to back of the laboratory fume hood along the countertop work surface.

18. The system of claim 17, wherein the air flow is increased around all sides of one or more laboratory equipment located on the upper surface of the platform.

19. A laboratory fume hood air channeling system comprising:
a platform comprising a lattice of interconnected horizontal slats forming a plurality of vertical air channels through the platform, the platform having sidewall surfaces, an upper surface, and a lower surface; and
support legs coupled exteriorly to the platform, configured to hold the platform above a countertop work surface of the laboratory fume hood, the countertop work surface and the lower surface of the platform forming an air chamber beneath the platform, the air chamber being in fluid communication with the vertical air channels to increase air flow through the vertical air channels and increase air flow horizontally from front to back of the laboratory fume hood along the countertop work surface,
wherein the sidewall surfaces, the upper surface, the lower surface, and vertical air channels together define a bulk volume of the platform, the bulk volume having void space defined by the vertical air channels, and
wherein the bulk volume comprises at least 70% void space.

20. The system of claim 19, wherein the air chamber being in fluid communication with the vertical air channels increases the air flow around all sides of one or more laboratory equipment located on the upper surface of the platform.
